(19) United States
(12) Patent Application Publication
(10) Pub. No.: US 2004/0071605 A1
(43) Pub. Date: Apr. 15, 2004

(54) Slide-based high-throughput microplate device

(76) Inventors: Everett W. Coonan, Painted Post, NY (US); Yulong Hong, Painted Post, NY (US); Fang Li, Painted Post, NY (US)

Correspondence Address: CORNING INCORPORATED, SP-TI-3-1, CORNING, NY, 14831

(21) Appl. No.: 10/682,742

(22) Filed: Oct. 9, 2003

Related U.S. Application Data
(60) Provisional application No. 60/418,101, filed on Oct. 10, 2002.

(51) Int. Cl. B01L 3/00

(52) U.S. Cl. 422/102

(57) ABSTRACT

A high-though put analysis device that combines the technologies of slide-based microarrays and microplates is provided. The device comprises a base with slots for holding a number of planar substrates, which may be printed with at least an array of biological or chemical molecules of interest. The device also includes a portion, having a number of honeycombed cells, which engages a corresponding printed substrate, wherein the cells form fluid-tight seals with the substrate surface, around an array, to create individual wells like those in a conventional microplate.

### RELATED APPLICATION

This application claims the benefit of priority from U.S. Provisional Application No. 60/418,101, filed, Oct. 10, 2002, the content of which is incorporated herein by reference.

### FIELD OF INVENTION

The present invention embodies a design for an apparatus that marries multiwell microplate-based and slide-based microarray technologies in one convenient device. More particularly, the present invention relates to an apparatus that can create wells like those in a conventional microplate on the surface of a thin planar substrate, such as glass slides, for high-throughput array-based assays.

### BACKGROUND

Slide-based microarray analysis is widely used in a variety of biological and chemical assays, which may include profiling mRNA expression or pharmaceutical drug discoveries. In the former application, thousands of cDNA or oligonucleotides can be printed on a single glass slide and the regulations of those genes under a defined condition can be profiled simultaneously. For the latter, many more drug target candidates will be identified through this technology in the next 5 to 10 years. The drawback of this type of slide-based array analysis, however, is low throughput, since only one sample can be tested for per slide. A great need exists for a high throughput platform to validate the identified candidates (usually a small set of genes) and to screen compounds against those candidates in large-scale, high-volume protocols.

Microplate-based array (i.e., arrays at the bottom of wells of a microplate) allows one to analyze dozens of samples simultaneously. Several companies have developed and demonstrated their proprietary systems for microplate-based array analysis, such as High Throughput Genomics, Inc. (HTG)'s Multiplex Molecular Profilings (MMP), Chromagen's HPSA technology platform, and Xanthon's Xanthon Xpression Analysis System. These high-throughput platforms, however, are currently not easily accessible to most clinical, research, or industrial customers who either do not wish or can not afford to purchase the entire instrumental system(s), which are quite expensive, offered by these companies. Another issue is that a lot of different chemistry has been developed on the glass slide surface for a variety of applications, which can not be easily adapted to polymer surfaces. Even a simple transfer of the existing surface chemistry from glass slides to glass bottom microplates is not as straight forward because the polymer part may interfere with the coating property. So far, there is no glass bottom microplates that have the desired chemistry on the market yet. Silicone chambers from Sigma offer a medium throughput solution with which 12 virtual wells can be formed on a single slide, and up to 12 hybridization could be processed simultaneously. After washing and drying, the slide was scanned using a conventional slide-array scanner, which is widely available. Although this process may mimic microplate-based assays, the apparatus is not even close to a real high-throughput platform in terms of the number of samples and automation. Currently, workers in the field are forced to purchase separately components from different suppliers and jury-rig the components together with a sheet of adhesive, such as available from Grace Bio Labs, Inc. Such contraptions are both difficult to use, since once assembled they can not be disassembled, and suffer potential contamination from the adhesive. A more cost-efficient, simple and versatile high-throughput array platform is thus desirable.

### SUMMARY OF THE INVENTION

The present invention pertains in part to a device for biological and chemical assays. The proposed device comprises a slide-holder, in which a number of planar substrates (e.g., microscope-sized slides) can fit side by side. The slide-holder has a section, preferably articulated or hinged, that closes over each corresponding slide. Each of the articulated sections, also referred to as a hollow plate, has a number of open or hollow cells or chambers, arranged in a honeycomb matrix of intersecting sidewalls. Each cell is defined by at least a sidewall with a first and second terminal edge and is oriented, when engaged, with an open end directed toward a surface of each slide. Around each cell, at the terminal edge of the sidewall that comes into contact with the slide, is a sealing mechanism, which forms a fluid-tight seal between the cell and the slide when the two are engaged with each other. The device can be used as a new platform for high throughput array-based analysis. In a preferred embodiment, the device can hold four (4) microscope slides with a corresponding number of hinged sections. Each articulated section has either a 3×8 or 6×16 matrix of cells. The matrix of cells can create a virtual microplate of 24 or 96 wells, respectively, on the surface of a single slide. Across the four slides in combination, the device can form as a whole a virtual microplate with an industry-standard footprint of either 96 or 384 wells, which can be handled with standard robotics commonly used in an automation laboratory. Alternatively, either a single hollow plate or a combination of hollow plates has a matrix of cells, which forms a virtual microplate with an industry-standard footprint of 96 or 384 wells. Other embodiments may have planar substrates (e.g., coated-glass, membrane, polymer-based, etc.) that vary in size from a standard 1×3 inch slide to a sheet that can contain an entire virtual microplate of an industry-standard footprint.

According to another aspect, the present invention pertains to a method for performing high-throughput analysis, such as for genomic or proteomic assays. The array-based method comprises several steps. First, either print at least an array, preferably multiple arrays, on a surface of a slide or provide a slide already with printed arrays. Second, provide a device as described above. Third, place or load the printed slide into a recess or tray in the base of the device. Fourth, close and secure a corresponding hinged section over the slide, such that the terminal edge of each sidewall of each open cell is engaged with the surface of the slide to form a fluid-tight seal. Thereby, each open cell creates an individual well, which encompasses each printed array on the slide surface. The slide forms the bottom surface of each well in a virtual microplate. Fifth, load samples of biological or chemical analytes or reagents into each well of the virtual microplate. The samples can be all of the same material or each of a different material. Then, perform an assay. After the assay has run, open and remove the slide from the device. If appropriate, wash and dry the slides. Finally, view and analyze the assay results from the slides, such as using a standard array scanner. Or, one may proceed to washing steps, if required, with a standard platewasher without taking the virtual microplate apart, and visualize the assay results with an imaging system that can directly read microplates. In another embodiment, the sequence of the first four steps may be reordered. Having first provided a device as described above, one may first place or load slide(s) into a recess or tray in the base of the device. Close and secure a corresponding hollow plate section over the slide(s), such that the terminal edge of each sidewall of each open cell is engaged with the surface of the slide to form a fluid-tight seal. Thereby, each open cell creates an individual well, which can encompass a printed array on the slide surface, wherein the slide forms the bottom surface of each well in a virtual microplate. Then, print an array in each individual well for array-based assays, or perform conventional microplate-based assays and obtain results using a plate-reader.

Additional features and advantages of the present invention will be explained in the following detailed description. It is understood that the foregoing and following descriptions and examples are merely representative of the invention, and are intended to provide an overview for understanding the invention as claimed.

### BRIEF DESCRIPTION OF THE DRAWINGS

FIG. 1 depicts an embodiment of a slide-holder/microplate device according to the present invention, having hollow plates, each with a 24-well matrix, for a combined-total potential of 96 wells.

FIG. 2 depicts an iteration of the base plate of a slide-holder, having a number of recesses to receive microscope slides arranged side by side.

FIGS. 3A and 3B depict, according to two embodiments, a hollow plate having a honeycomb matrix of cells as defined by at least a sidewall. FIG. 3A illustrates a rigid a honeycomb matrix of cells of a unitary construction. FIG. 3B illustrates a rigid frame enveloping a well-block of compliant (sealable) material, which forms individual cells.

FIGS. 4A & B depict, in schematic views, an alternate embodiment of a hollow plate.

FIG. 5 shows a cross-sectional view along the width of an assembled virtual 96-well microplate like that depicted in FIG. 1, according to the present invention.

FIGS. 6A-C show a series of views of a schematic of one way a hollow-plate, or hinged section, engages with a slide.

FIG. 7 depicts a second embodiment of the slide-holder/microplate device having hollow plates each with a 96-well matrix, for a total potential of 384 wells.

FIG. 8 is a representation of the general steps of a method for performing high-throughput analysis according to the present invention.

### DETAILED DESCRIPTION OF THE INVENTION

The present apparatus is a versatile high-throughput platform for performing biological or chemical assays. The apparatus could be used, preferably, for any type of array-based or microplate-based assay, such as for target validation, including, for example, pharmaceutical drug screening, clinical diagnostics, genomics, and proteomics. Assays may involve the use of DNA/oligonucleotide “theme” arrays, antibody/protein/peptide “theme” array, tissue/cell array, and other small molecule arrays. As used herein the term “theme array” refers to an array having a select sample of particular biological or chemical materials of interest (e.g., with one biological or chemical molecules per well, if desired). The uses to which the invention can be applied, however, are not limited to only array-based assays. The apparatus may also be used for any surface-mediate or surface-attachment required assays, such as, ELISA, kinase assays, or cell-based assays.

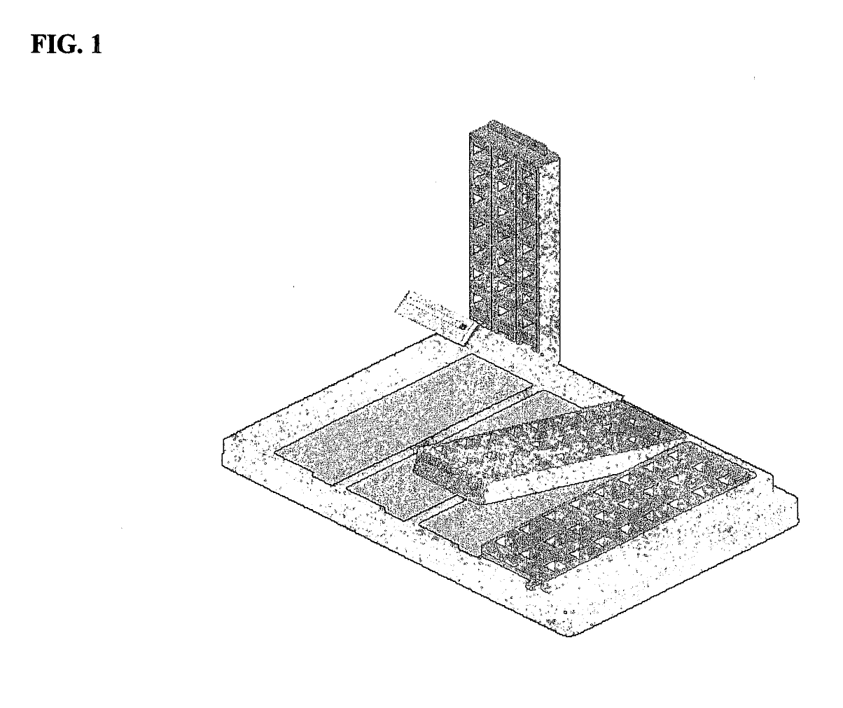

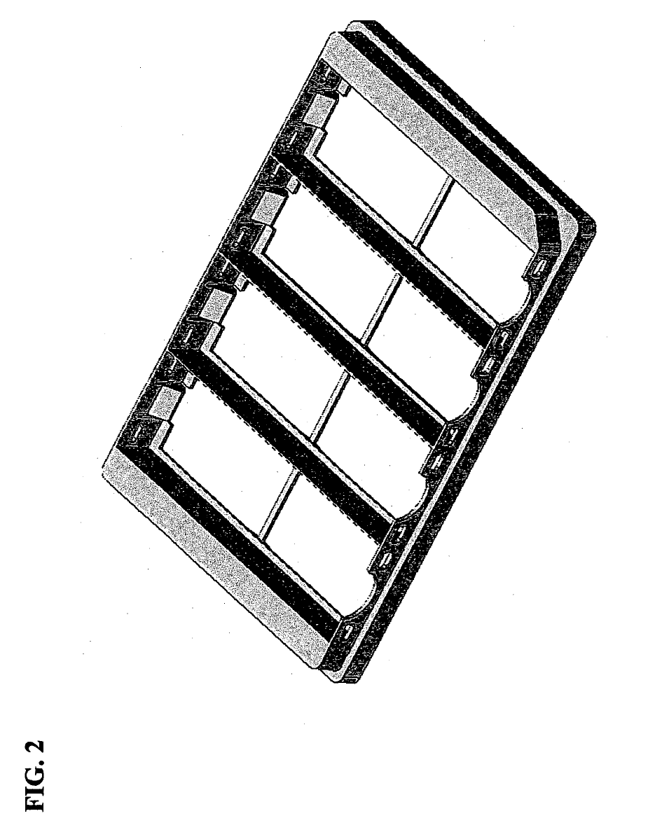

The present device or assembly is made of a number of parts working in concert, as depicted in FIG. 1, which shows in perspective an overall view of an embodiment of the present device. The device 10 comprises a slide-holder 12, and a number of articulated hollow plate 18 sections. The slide-holder 12 can accommodate a plurality of glass slides 2, side by side (e.g., four (4) slides), in recesses 14 or niches of a base plate 16. FIG. 2 shows a base plate having four recesses. It is envisioned that the base will be machined or injection molded from a rigid, dimensionally stable plastic material or from metal (e.g., aluminum). It can be designed for reuse or onetime use.

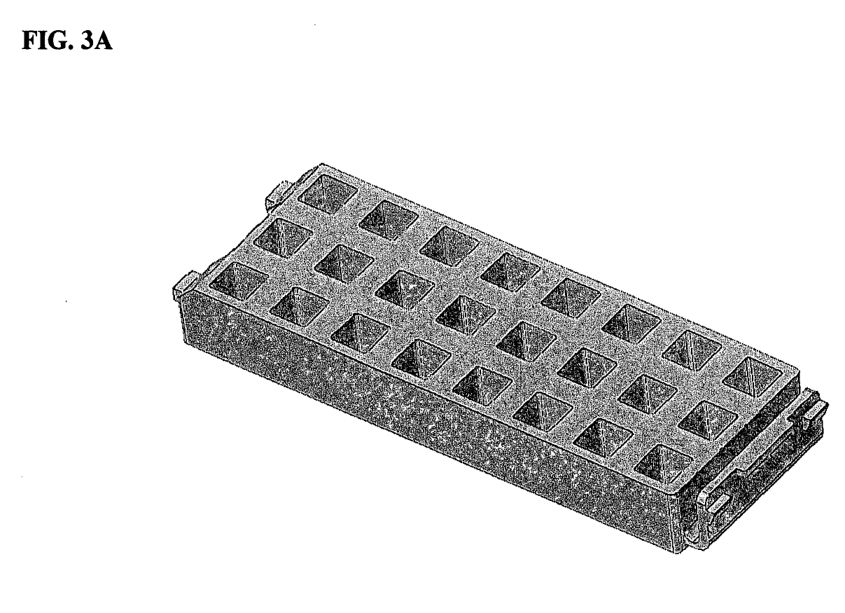

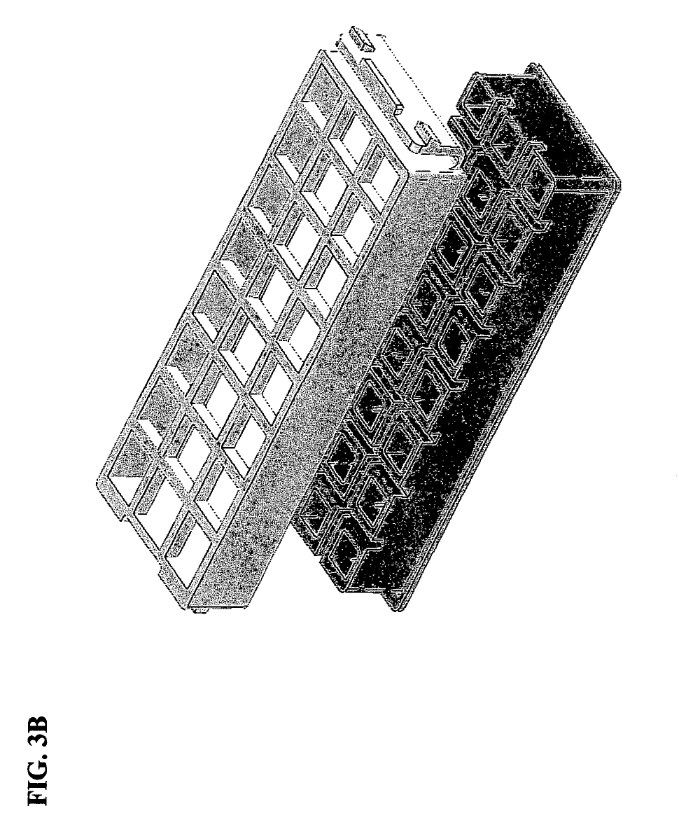

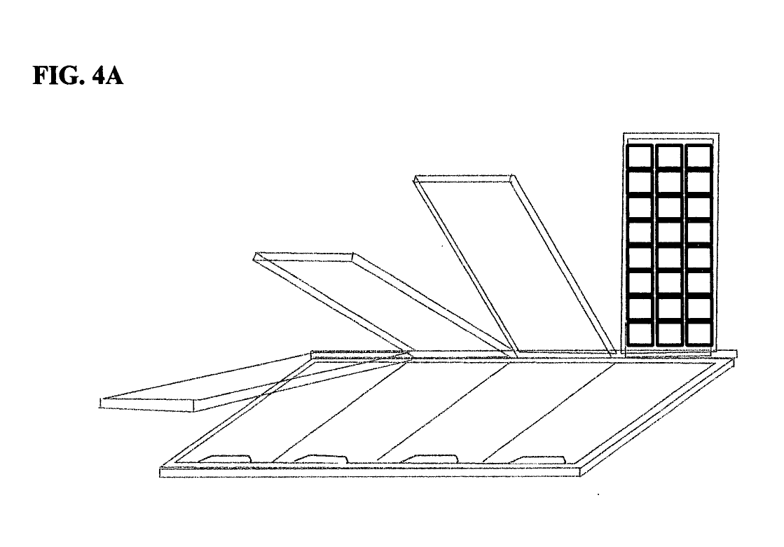

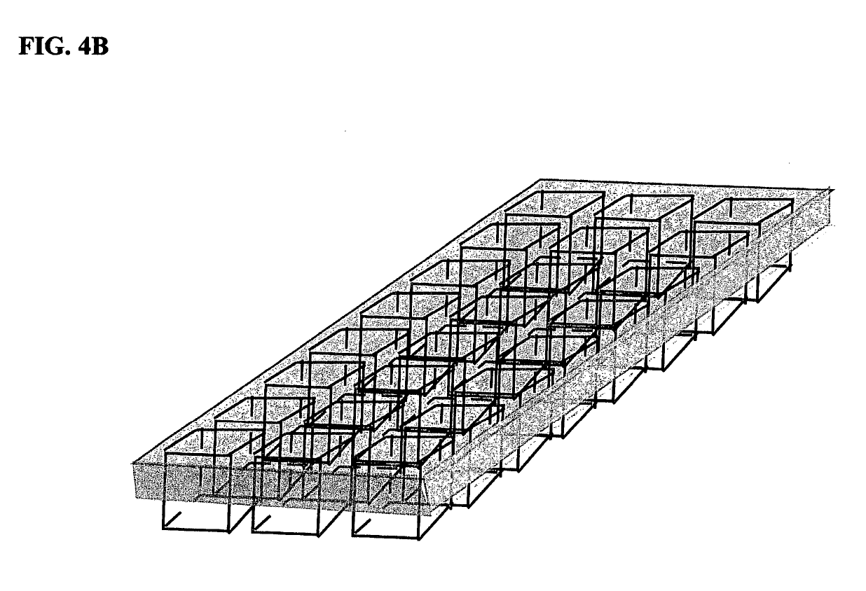

A corresponding number of hollow plates 18, each made of a honeycomb 20 of open cells 22, with preferably orthogonally intersecting sidewalls, are attached at a first end 24 of the hollow plate 18 to the slide-holder 12. FIGS. 3A, 3B, and 4, each illustrates an alternate embodiment of a hollow plate 18. The attachment element is preferably a hinge 26 or some other flexible mechanism for ease of displacing the hollow plates when accessing the slides in the slide-holder. Alternatively, the hollow-plate may be an independent article separate from the slide-holder base. According to an embodiment, one end of the hollow plate has a tab or some other element, which engages a mating feature on the base, for example, a snap into a slot on either side or both of the base plate, as FIG. 2 shows in detail, which positions and secures the first or back end of the hollow plate. The opposing second or front end 28 of each individual hollow plate 18 section can be either secured (e.g., with a clamp, snap, or friction-fit with a mating feature on the base) to maintain the hollow plate in position and firmly in contact with a microscope slide in the slide-holder or flipped open, such as depicted in FIG. 1.

FIG. 3B illustrates an alternative design for a hollow plate. The hollow plate can be made from a rigid relatively thin-walled frame 40, which encloses a relatively thick block 42 of compliant (i.e., elastomeric, deformable, and conducive to forming a seal with the substrates) material containing a matrix of open cells 43. The frame has a top, horizontal surface 44 with well openings 22b, two substantially vertical side wall surfaces 46 extending from the horizontal surface, and two ends 47, 49, which engage the base plate as described above. The elastomeric material 42, containing the matrix of cells, is assembled and secured to the rigid frame 40, such that a portion protrudes below the edge of the frame's sidewalls and seals against a substrate, like a microscope slide. Thus, when engaged, the hollow plate may be also referred to as a “well-block.”

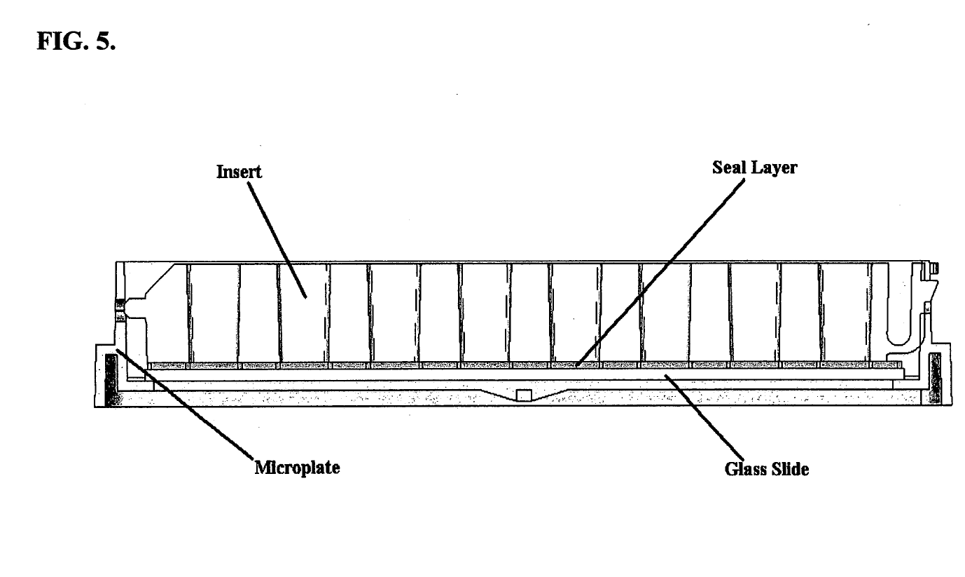

FIG. 5 shows in cross-section a hollow plate 18 having a thin sealing layer 50, according to the embodiment of either FIG. 3A or 3B, forming a seal with a glass slide 2 across the bottom of a number of wells 22.

The hollow plates can be made of a variety of materials, so long as the terminal edge of the cellular sidewall, which contacts a slide, is outfitted with a material that can form a fluid-tight seal against the surface of glass slides. Examples of suitable materials may include, but not limited to: rubber, silicone, a rigid plastic (e.g. polystyrene, polypropylene, olefin, etc.), or some other materials, preferably of a grade suitable for injection molding. It is envisioned in an embodiment that the hollow plates will be manufactured by a “two-shot” injection molding process, in which the first shot would form the rigid, main body of the hollow plate containing the matrix of open cells, and end features that interface with the base. The second shot would “overmold” a thermoplastic elastomer onto the bottom edge of the plate to provide a compliant, liquid-sealing surface against a microscope slide. The elastomer should be compatible for fusion binding with the material of the hollow plate, but compliant enough to seal. Hence, the elastomeric material should be of a low durometer value. For example, a material such as SEBS (styrene-ethylene/butylenes-styrene) tri-block copolymer could be a suitable choice with a polystyrene body.

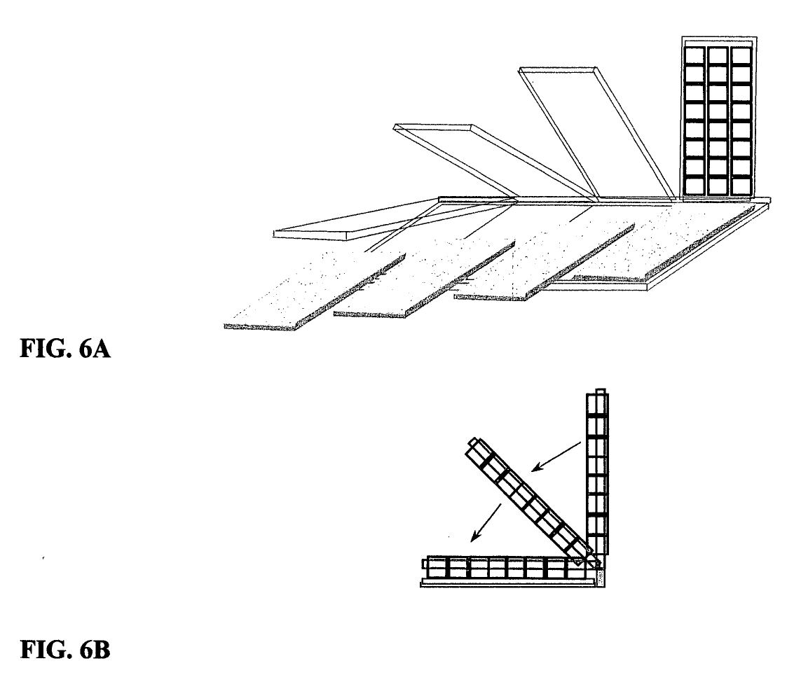

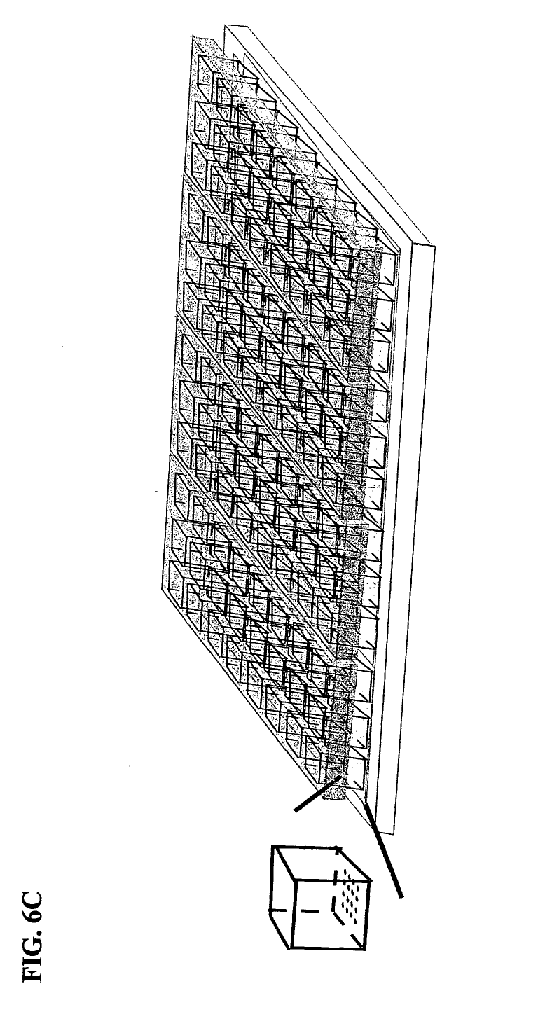

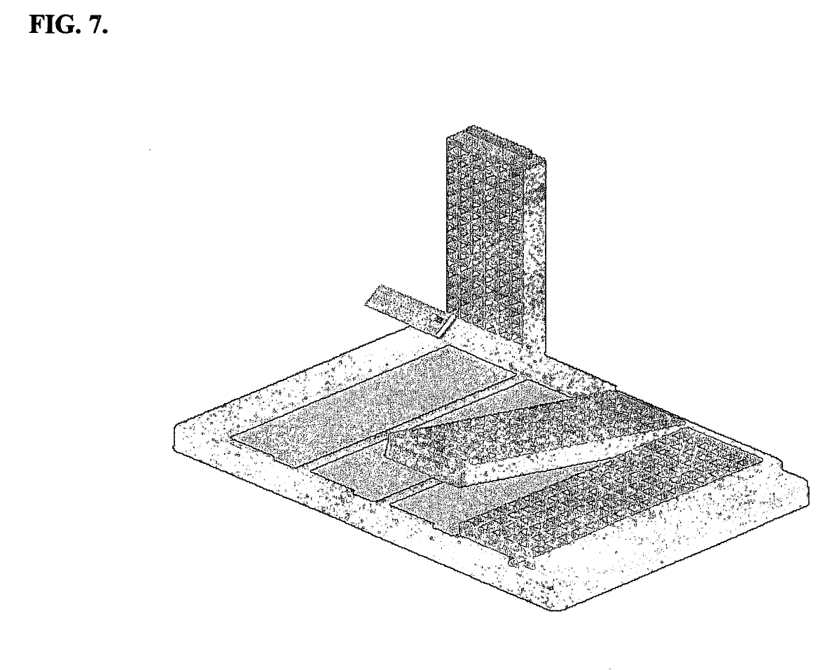

FIG. 6 shows, in a series of views, a schematic of the way a hollow-plate engages with a slide. Once engaged with the underlying slide 2, each cell 22 in a hollow plate 18 creates a well 22a on the surface 4 of the slide 2, with the slide itself serving as the bottom surface of the well. In FIG. 5C, one cell is enlarged to show an array on the surface of a slide being completely enclosed within the confines of a rectilinear cell. Nonetheless, the wells and their bottoms could have a circular, square, rectangular, polygon or any other shaped footprint. The dimension of the whole apparatus, preferably, is identical to a standard microplate. For example, in a 96-well version, the on-center distance between each well matches that of those in a 96-well microplate, so that all standard microplate liquid handlers or robots currently available can be used. Conceptually, the matrix of cells 22 in a hollow plate 18 forms a block or strip of open-bottom wells 22a. Each well-block can contain as many cells/wells as is limited only by the thickness of the cellular sidewalls and the size of the printed arrays on each slide. With some more common embodiments, there may be 8-100 wells in each well-block. Preferred embodiments, such as illustrated in FIGS. 1 and 7, however, have well-blocks with a 24 (3×8) or 96 (6×16)-well matrix, respectively, for a combined-total potential of 96 or 384 wells across four slides—8×12 (96) or 12×24 (384). Other matrix formats are also contemplated. Alternatively, the well-block can comprise either two sections, each of 48 (6×8) or 384 (12×16) cells/wells, or be a single piece containing either 96 (8×12) or 384 (16×24) cells/wells.

In another aspect, the invention provides a method for high throughput array-based assay. The method comprises: 1) providing a planar substrate; 2) providing a device that includes: a slide-holder having a base with recesses that can accommodate a number of planar substrates; a hollow plate having a matrix of cells; the hollow plate engages with said base at a first end by an attachment mechanism, and at a second end with a securing mechanism, which holds in place each hollow plate against a surface of each planar substrate; 3) assemblying the planar substrate in the device; 4) printing at least an array on said planar substrate; 5) performing an assay. In an embodiment, a single-well assay can be performed in each cell for a single sample.

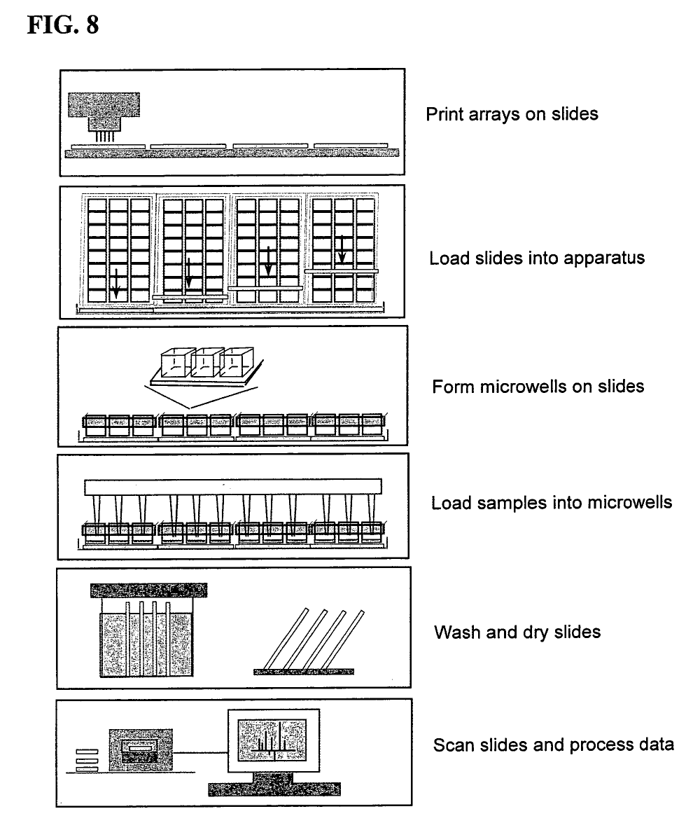

According to a second embodiment, the method comprises six major steps. Other steps may be substituted or additionally included. First, either print an array on a slide or provide a preprinted slide(s). For instance, each slide is preprinted with 24 subgrids, each subgrid consisting of an array of small biological or chemical molecules of interest (cDNA, oligonucleotides, proteins, peptides, cells or other small molecules, etc.). The location of each subgrid on the slide is precisely positioned so that it will be inside a well formed with the hollow plates of the apparatus described above. Second, load the slide(s) into the slide holder. Third, engage the hollow plate against the slide to create a liquid-tight seal for a virtual well. Then, close and secure each hollow plate section at its free end. Fourth, introduce reaction solutions into each virtual well, such as by using a microplate liquid-handler or multiple channel pipettor. Fifth, after the assay is done, open and remove the slides from the device. The slides are washed and dried following a standard slide-based microarray assay protocol. Sixth, scan, such as by using an array scanner, or otherwise view each slide for data analysis. By means of the present, simple yet elegant apparatus, a large number (e.g., 96-384) of reactions can be performed simultaneously and the whole process can be automated, as illustrated in schematic form in FIG. 8. If an imaging system that can detect arrays in microplate wells is available, one can work with the assembled virtual microplates throughout the assay steps.

The new platform offers a number of advantages over previous systems and devices. The advantages, just to name a few, include the following. First, this device enables one to take advantage of all existing surface chemistries that may be built onto the glass slide surface. No further development or additional modification of the surface chemistry is required in order to transfer slide-based assays to microplate-based assays. Second, the new apparatus can achieve a true industry-standard microplate footprint with respect to the number of arrays or individual assays one may be able to execute by means of true parallel processing. Hence, third, the device is fully compatible with a range of standard slide or microplate-associated instruments. All of the conventional lab instruments (e.g., glass slide arrayer/scanner, microplate liquid handler, etc.) that one would likely find in an industrial, clinical or research laboratory are readily usable. Users of the inventive platform need not incur extra costs for new equipment since the new platform combines the slide-based array and microplate-based high-throughput technologies. This feature is one of the significant advantages over other commercially available microplate-based array systems, which typically require the user to buy expensive new instrument(s). Fourth, the device has a modular design, which workers can assemble and disassemble with ease for flexibility-of-use as they may desire. Fifth, the inventive device is inexpensive and disposable.

The present invention has been described generally and in detail by way of examples and figures. Persons skilled in the art, however, will understand that the invention is not limited necessarily to the embodiments specifically disclosed, but that modifications and variations can be made without departing from the spirit of the invention. Therefore, unless changes otherwise depart of the scope of the invention as defined by the following claims, they should be construed as being included herein.

We claim:

1. An analysis device comprising:
a slide-holder having a base in which a number of planar substrates can fit side by side;
a hollow plate having a number of open cells, arranged in a honeycomb matrix;
each hollow plate being able to engage with said base and be in contact with a corresponding slide;
each cell in said hollow plate has a sealing mechanism, which forms a fluid-tight seal between said cell and a surface of said planar substrate, to create a well.

2. The device according to claim 1, wherein said slide-holder can accommodate four (4) microscope slides.

3. The device according to claim 2, wherein a corresponding number of hollow plates are engaged with said base.

4. The device according to claim 1, wherein said hollow plate is engaged with said base at a first end by a hinged mechanism.

5. The device according to claim 1, wherein said hollow plate is secured to said base plate at a second end.

6. The device according to claim 1, wherein in each hollow plate said cells are arranged in a 3×8 matrix.

7. The device according to claim 1, wherein in each hollow plate said cells are arranged in a 6×16 matrix.

8. The device according to claim 1, wherein said matrix of cells creates a virtual microplate of 24 wells on the surface of each slide.

9. The device according to claim 1, wherein said matrix of cells creates a virtual microplate of 96 wells on the surface of each slide.

10. The device according to claim 2, wherein a virtual microplate with an industry-standard footprint of 96 wells is formed with said four slides in combination.

11. The device according to claim 2, wherein a virtual microplate with an industry-standard footprint of 384 wells is formed with said four slides in combination.

12. The device according to claim 1, wherein said device can be assembled and disassembled with ease.

13. A device for performing biological or chemical assays, the device comprising: a slide-holder having a base with recesses that can accommodate a number of planar substrates; a hollow plate having a matrix of cells; said hollow plate engages with said base at a first end by an attachment mechanism, and at a second end with a securing mechanism, which holds in place each hollow plate against a surface of each substrate.

14. The device according to claim 13, wherein each cell is defined by at least a sidewall with a first and second terminal edge and is oriented with an open end directed toward a surface of each planar substrate.

15. The device according to claim 13, wherein said slide-holder can accommodate four (4) microscope slides.

16. The device according to claim 13, wherein in each hollow plate having a number of cells that are arranged in an 8×12 matrix to form 96 wells.

17. The device according claim 13, wherein in each hollow plate having a number of cells that are arranged in a 16×24 matrix to form 384 wells.

18. The device according to claim 13, wherein the device has two hollow plates, each with a matrix of 48 (6×8) or 192 (12×16) cells.

19. The device according to claim 13, wherein said hollow plate is molded by means of a two-shot injection molding process.

20. The device according to claim 13, wherein said hollow plate comprises a rigid frame enclosing an elastomeric block containing a matrix of open cells.

21. A method performing array-based assays, the method comprising:
a) either printing at least an array on a major surface of a slide, or providing a slide already with printed arrays;
b) providing a device comprising: a slide-holder having a base in which a number of microscope-sized slides can fit side by side; a hollow plate having a number of open cells, arranged in a honeycomb matrix; each hollow plate being able to engage with said base and a corresponding slide; each cell in said hollow plate has a sealing mechanism, which forms a fluid-tight seal between said cell and a surface of said slide;
c) placing said printed slide into a recess in said base of said device;
d) closing and securing a corresponding hollow plate over said slide;
e) forming a fluid-tight seal between a terminal edge of a sidewall of each open cell and said printed surface of said slide, wherein each open cell creates an individual well on the slide surface;
f) loading samples of either biological analytes or chemical reagents into each well;
g) performing an assay.

22. The method according to claim 21, wherein said samples can be all of the same material or each of a different material.

23. The method according to claim 21, further comprises opening and removing said slide from said slide-holder.

24. The method according to claim 21, further comprises washing and drying said slide.

25. The method according to claim 21, further comprises viewing and analyzing the results of said assay.

26. The method according to claim 21, wherein in each hollow plate said cells are arranged in a 3×8 matrix.

27. The method according to claim 21, wherein in each hollow plate said cells are arranged in a 6×16 matrix.

28. The method according to claim 21, wherein said matrix of cells creates a virtual microplate of 24 wells on the surface of each slide.

29. The method according to claim 21, wherein said matrix of cells creates a virtual microplate of 96 wells on the surface of each slide.

30. A method of performing an assay, the method comprising:
a) providing a planar substrate;
b) providing a device that comprises: a slide-holder having a base with recesses that can accommodate a number of planar substrates; a hollow plate having a matrix of cells; said hollow plate engages with said base at a first end by an attachment mechanism, and at a second end with a securing mechanism, which holds in place each hollow plate against a surface of each planar substrate;
c) assemblying said planar substrate in said device;
d) printing at least an array on said planar substrate;
e) performing an assay.

31. The method according to claim 30, wherein said samples can be all of the same material or each of a different material.

32. The method according to claim 30, further comprises opening and removing said slide from said slide-holder.

33. The method according to claim 30, further comprises analyzing the results of said assay.

34. The method according to claim 30, wherein either a single hollow plate or a combination of hollow plates has a matrix of cells, which forms a virtual microplate with an industry-standard footprint of 96 wells.

35. The method according to claim 30, wherein either a single hollow plate or a combination of hollow plates has a matrix of cells, which forms a virtual microplate with an industry-standard footprint of 384 wells.
